(19) United States
(12) Patent Application Publication
(10) Pub. No.: US 2020/0370594 A1
(43) Pub. Date: Nov. 26, 2020

(54) ROLLING BEARING ATTACHMENT STRUCTURE

(71) Applicant: JTEKT CORPORATION, Osaka-shi, Osaka (JP)

(72) Inventors: Kunihiro YAMAGUCHI, Nagoya-shi (JP); Kensuke KIMURA, Yokohama-shi (JP)

(73) Assignee: JTEKT CORPORATION, Osaka-shi, Osaka (JP)

(21) Appl. No.: 16/771,003

(22) PCT Filed: Dec. 6, 2018
(86) PCT No.: PCT/JP2018/044948

§ 371 Date: Jun. 9, 2020

(30) Foreign Application Priority Data
Dec. 15, 2017 (JP) 2017-240786

(51) Int. Cl. F16C 9/02; F16C 35/063

(52) U.S. Cl. CPC F16C 9/02; F16C 33/60; F16C 35/063

(57) ABSTRACT

A rolling bearing attachment structure for attaching a rolling bearing to a journal portion of a crankshaft includes: the rolling bearing; and the crankshaft. The rolling bearing is attached to an outer peripheral surface of the journal portion, and includes: a pair of two-split inner rings which are split into two portions in a circumferential direction; a pair of two-split outer rings which are provided on a radial direction outer side of the two-split inner rings and are split into two portions in the circumferential direction; a plurality of rolling elements rotatably provided between the pair of two-split outer rings and the pair of two-split inner rings; and a cage which holds the plurality of rolling elements at substantially equal intervals in the circumferential direction.

### TECHNICAL FIELD

One aspect of the present invention relates to a rolling bearing attachment structure.

### BACKGROUND ART

Various rolling bearings which are divided in a peripheral direction have been proposed as bearings for supporting a crankshaft. For example, a rolling bearing described in Patent Literature 1 (JP-A-2010-117008) includes: a two-split inner ring formed by a first two-split inner ring member and a second two-split inner ring member; a two-split outer ring formed of a first two-split outer ring member and a second two-split outer ring member; and a plurality of rollers. The two-split inner ring is sandwiched and held in an axial direction by crank arms provided on two axial direction sides of a journal portion of a crankshaft and is thus attached to the journal portion.

### CITATION LIST

### Patent Literature

### [Patent Literature 1] JP-A-2010-117008

### SUMMARY OF INVENTION

### Technical Problem

However, in the rolling bearing described in Patent Literature 1, when a large load is applied to a peripheral direction center of the first two-split inner ring member and/or the second two-split inner ring member, a gap is generated between facing end portions of the first two-split inner ring member and the second two-split inner ring member, passing vibration generated when the roller passes through a split portion is increased, thus noise and vibration (hereinafter, referred to as “NV”) may occur, and early peeling may occur due to an increase in contact surface pressure. Moreover, when a fixing force is insufficient, the two-split inner ring rotates with respect to the journal portion, and a large load is applied to the split portion, which may lead to early peeling and the like and reduce service life of the bearing.

The present invention has been made in view of the above circumstances, and an object thereof is to provide a rolling bearing attachment structure capable of reducing lifting and deformation of the split portion and restraining rotation of the two-split inner ring with respect to the journal portion when the large load is applied to the two-split inner ring.

### Solution to Problem

In a first aspect, a rolling bearing attachment structure for attaching a rolling bearing to a journal portion of a crankshaft, includes the rolling bearing and the crankshaft. The rolling bearing includes a pair of two-split inner rings which is attached to an outer peripheral surface of the journal portion and is split into two portions in a circumferential direction, a pair of two-split outer rings which is provided on outer sides of the pair of two-split inner rings in a radial direction and is split into two portions in the circumferential direction, a plurality of rolling elements rotatably provided between the pair of two-split outer rings and the pair of two-split inner rings, and a cage which holds the plurality of rolling elements at substantially equal intervals in the circumferential direction. The crankshaft includes a pair of crank arms provided on two axial direction sides of the journal portion. The pair of crank arms includes a caulking margin, at least a part of the caulking margin in a peripheral direction protruding radially outward from a facing end surface facing an axial direction face of the pair of two-split inner rings. The pair of two-split inner rings is sandwiched in an axial direction by the pair of crank arms. An outer peripheral surface of the pair of two-split inner rings is fixed by a caulked portion formed by caulking the caulking margin.

In a second aspect, in the rolling bearing attachment structure according to the first aspect, the pair of two-split inner rings includes a pair of rib portions which protrudes radially outward from two axial direction end portions, and the caulking margin is caulked to an outer peripheral surface of the pair of rib portions.

In a third aspect, in the rolling bearing attachment structure according to the first aspect or the second aspect, the pair of two-split inner rings includes a plurality of recessed portions formed at equal intervals in the peripheral direction in the outer peripheral surface where the caulking margin is caulked.

In a fourth aspect, in the rolling bearing attachment structure according to any one of the first aspect to the third aspect, the pair of two-split inner rings includes a concave-convex structure constituted by a plurality of recessed portions or protruding portions formed at equal intervals in the peripheral direction in two axial direction face of the rings.

In a fifth aspect, the rolling bearing attachment structure according to any one of the first aspect to the fourth aspect, the pair of two-split inner rings includes a concave-convex structure constituted by a plurality of recessed portions or protruding portions formed at equal intervals in the peripheral direction in an inner peripheral surface.

### Advantageous Effects of Invention

According to the first aspect, since the caulking margin protrudes radially outward in at least a part of the peripheral direction from the facing end surface portion of the crank arm, which faces the axial direction face of the ring of the two-split inner rings, the caulking margin can be easily formed. Moreover, the outer peripheral surface of the pair of two-split inner rings is fixed by the caulked portion formed by caulking the caulking margin in a state where the pair of two-split inner rings is sandwiched in the axial direction by the pair of crank arms. As a result, since two axial direction end edge portions of the outer peripheral surface of the two-split inner rings are pressed radially inward by the caulked portion and fixed, lifting and deformation of a split portion can be reduced, and rotation of the two-split inner rings with respect to the journal portion can be restrained when a large load is applied to the two-split inner rings. Consequently, the passing vibration generated when the roller passes through the split portion can be reduced, and NV reduction can be achieved.

According to the second aspect, since the pair of rib portions protrudes radially outward from the two axial direction end portions of the pair of two-split inner rings, an area of the two axial direction face of the rings of the two-split inner rings can be increased, a holding force of the sandwiching of the pair of crank arms can be increased, and thus a fixing force can be improved. Interference between the cage, which holds the roller, and the crank arms can be prevented, and wear of the cage can be prevented. Moreover, since the caulking margin is caulked to the outer peripheral surface of the pair of rib portions of the two-split inner rings, the two axial direction end edge portions of the outer peripheral surface of the two-split inner rings are pressed radially inward and fixed by the caulking. As a result, the lifting and deformation of the split portion can be reduced, and the rotation of the two-split inner rings with respect to the journal portion can be restrained when the large load is applied to the two-split inner rings. Consequently, the passing vibration generated when the roller passes through the split portion can be reduced, and NV reduction can be achieved.

According to the third aspect, since the plurality of recessed portions are formed at equal intervals in the peripheral direction in the outer peripheral surface of the pair of two-split inner rings where the caulking margin is caulked, the caulking margin can be fitted into the plurality of recessed portions, and the rotation of the two-split inner rings with respect to the journal portion can be further restrained.

According to the fourth aspect, the pair of two-split inner rings can be restrained from slipping with respect to the pair of crank arms due to the concave-convex structure formed on the two axial direction face of the rings, and the rotation of the two-split inner rings with respect to the journal portion can be further restrained.

According to the fifth aspect, the pair of two-split inner rings can be restrained from slipping with respect to the journal portion due to the concave-convex structure formed on the inner peripheral surface, and the rotation of the two-split inner rings with respect to the journal portion can be further restrained.

### BRIEF DESCRIPTION OF DRAWINGS

FIG. 1 is a front cross-sectional view of a rolling bearing according to a first embodiment.

FIG. 2 is a side view showing the rolling bearing shown in FIG. 1.

FIG. 3 is an exploded perspective view showing a two-split inner ring of the rolling bearing shown in FIG. 1.

FIG. 4 is a front cross-sectional view showing a journal portion before caulking of a crankshaft shown in FIG. 1.

FIG. 5 is an explanatory diagram for explaining caulking of a caulking margin shown in FIG. 4.

FIG. 6 is an explanatory diagram for explaining a state where the caulking margin shown in FIG. 4 is caulked.

FIG. 7 is a front cross-sectional view of a rolling bearing according to a second embodiment.

FIG. 8 is an exploded perspective view showing a two-split inner ring of the rolling bearing shown in FIG. 7.

FIG. 9 is a front cross-sectional view showing a journal portion before caulking of a crankshaft shown in FIG. 7.

FIG. 10 is an explanatory diagram for explaining caulking of a caulking margin shown in FIG. 9.

FIG. 11 is an explanatory diagram for explaining a state where the caulking margin shown in FIG. 9 is caulked.

FIG. 12 is an exploded perspective view showing a two-split inner ring of a rolling bearing according to a third embodiment.

FIG. 13 is an exploded perspective view showing a two-split inner ring of a rolling bearing according to a fourth embodiment.

FIG. 14 is an explanatory diagram of a concave-convex structure provided on two axial direction face of the rings of a two-split inner ring of a rolling bearing according to a fifth embodiment.

FIG. 15 is an explanatory diagram of a cutout groove provided on two axial direction face of the rings of a two-split inner ring of a rolling bearing according to a sixth embodiment.

### DESCRIPTION OF EMBODIMENTS

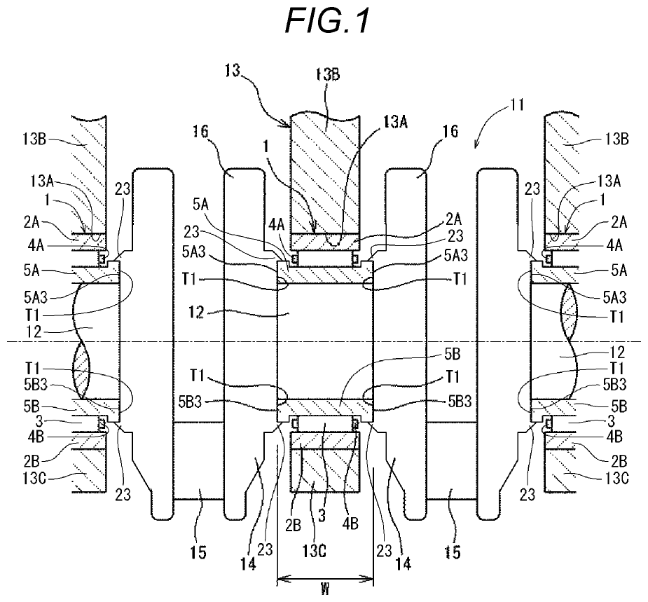

Hereinafter, a detailed description will be given based on first to sixth embodiments of a rolling bearing attachment structure according to the present invention with reference to the drawings. First, a rolling bearing 1 and a crankshaft 11 according to the first embodiment will be described with reference to FIGS. 1 to 6.

### First Embodiment

As shown in FIG. 1, the rolling bearing 1 according to the first embodiment is attached to an outer peripheral surface of a journal portion 12 of the crankshaft 11, and is fitted into a support hole 13A of a housing 13 provided in a crankcase. The housing 13 includes an upper block 13B and a lower block 13C. The support hole 13A is formed between the upper block 13B and the lower block 13C by bolting the lower block 13C to a lower surface of the upper block 13B.

The crankshaft 11 includes the journal portion 12, a crank arm 14, a crank pin 15, a balance weight 16, and the like. The journal portion 12 is provided at a rotation center position of the crankshaft 11, and is rotatably supported by the housing 13 via the rolling bearing 1. A plurality of the crank arms 14 are arranged side by side at intervals in an axial direction, and are connected to each other by the journal portion 12 and the crank pin 15. The crank pin 15 is provided at a tip end portion of the crank arm 14, and the balance weight 16 is provided at a rear end portion of the crank arm 14. The balance weight 16 may be formed integrally with the crank arm 14, or may be formed separately from the crank arm 14.

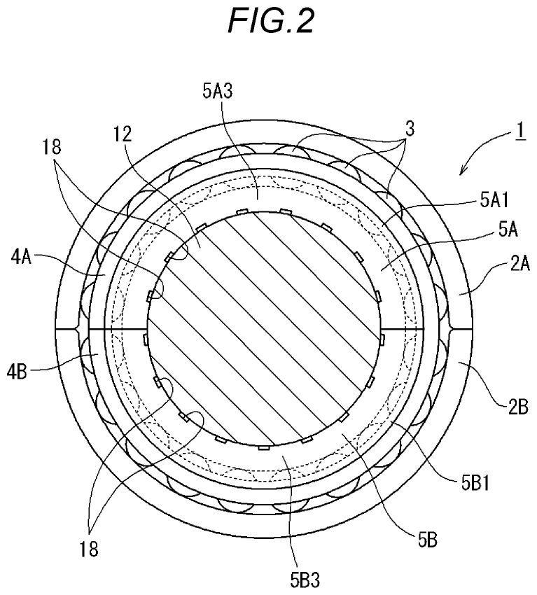

As shown in FIG. 2, the rolling bearing 1 includes: a pair of two-split outer rings 2A, 2B which are split into two portions in a circumferential direction; rollers 3, which are a plurality of rolling elements capable of rolling on inner peripheral surfaces of the two-split outer rings 2A, 2B; and a pair of two-split cages 4A, 4B which hold the rollers 3 so as to arrange the rollers 3 at equal intervals in the circumferential direction.

Further, the rolling bearing 1 includes a pair of two-split inner rings 5A, 5B which are split into two portions in the circumferential direction. Inner peripheral surfaces of the two-split inner rings 5A, 5B are fitted to the outer peripheral surface of the journal portion 12, and the rollers 3 are capable of rolling on outer peripheral surfaces of the two-split inner rings 5A, 5B. The cage which holds the rollers 3 at equal intervals in the circumferential direction is not limited to have a two-split structure, and may also have a ring structure divided at one location in the circumferential position, and the divided location may be expanded to be attached to the outer peripheral surfaces of the two-split inner rings 5A, 5B.

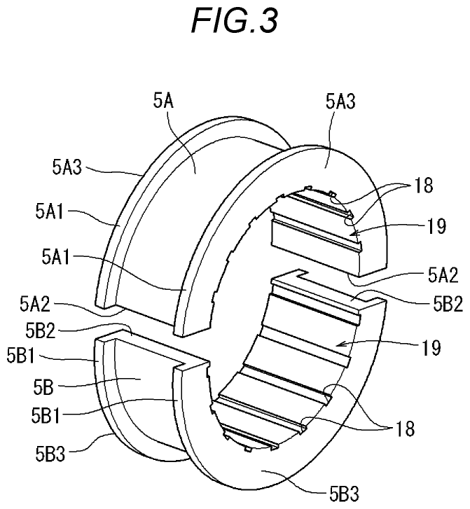

As shown in FIGS. 2 and 3, the two-split inner rings 5A, 5B are made of bearing steel such as SUJ2, and have desired performance such as hardness (for example, HRC 58 or more), mechanical strength, and wear resistance to serve as a raceway of the rolling bearing 1. The two-split inner rings 5A, 5B are formed in semicircular arc shapes, and are respectively formed with rib portions 5A1, 5B1 which protrude radially outward with a predetermined width (for example, about 3 mm in width) from two axial direction end edge portions of the outer peripheral surface and guide the two-split cages 4A, 4B.

The two-split inner rings 5A, 5B respectively include divided surfaces 5A2, 5B2 whose two circumferential direction end surfaces extend straight along the axial direction. The two-split inner rings 5A, 5B abut against each other on the divided surfaces 5A2, 5B2 at two circumferential direction ends, or face each other with a slight gap therebetween formed in the circumferential direction. A large number of fine grooves 18, which extend along the axial direction and have a depth of about 0.1 mm to 0.2 mm, are formed in the inner peripheral surfaces of the two-split inner rings 5A, 5B at substantially equal intervals in a peripheral direction. Accordingly, a concave-convex structure 19 is formed on the inner peripheral surfaces of the two-split inner rings 5A, 5B by the fine grooves 18 which are substantially uniformly distributed in the peripheral direction of the inner peripheral surfaces.

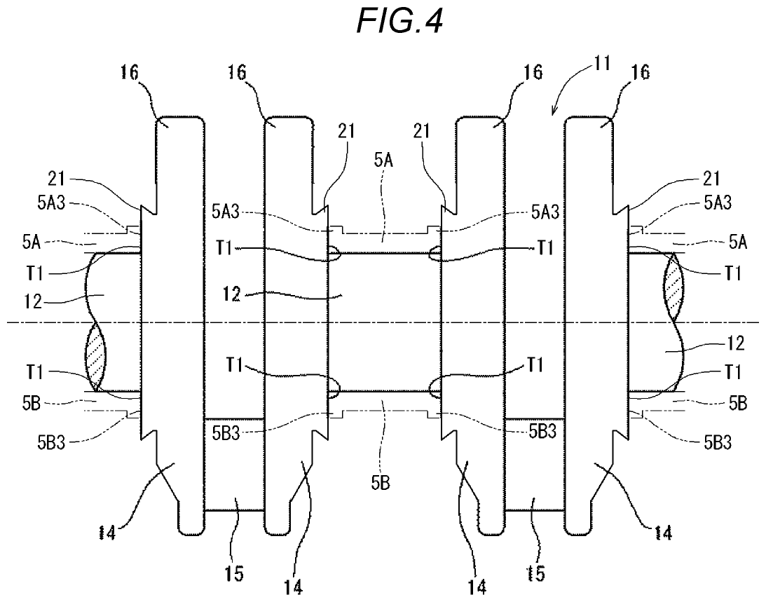

As shown in FIG. 4, when the two-split inner rings 5A, 5B are fitted to the journal portion 12, a caulking margin 21 is formed, which protrudes radially outward over the entire circumference from facing end surface portions T1 of the crank arms 14 to which two axial direction face of the rings 5A3, 5B3 of the two-split inner rings 5A, 5B face. The caulking margin 21 protrudes radially outward to be flush with the facing end surface portion T1, and a radial direction cross section of an outer peripheral portion thereof is formed in a right-angled triangular shape whose diameter is continuously reduced from one side to the other side in the axial direction. As described below, the caulking margin 21 is set to press and fix outer peripheral surfaces of the rib portions 5A1, 5B1 of the two-split inner rings 5A, 5B when the caulking margin 21 is caulked (see FIG. 6).

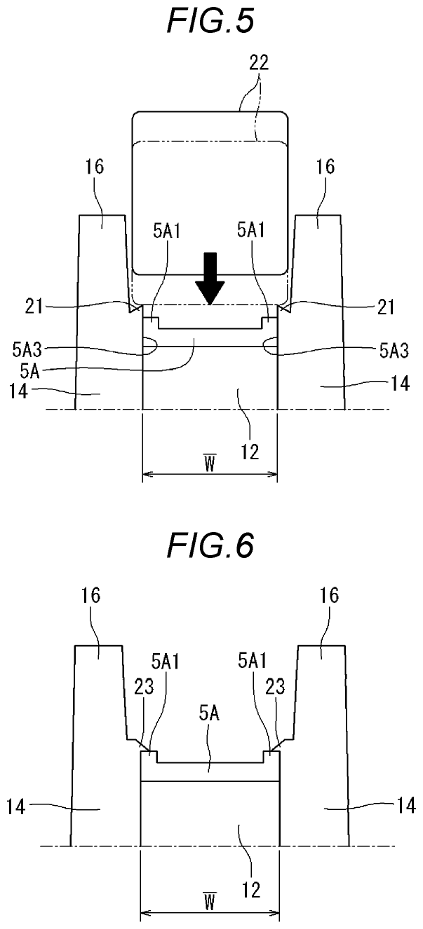

As shown in FIGS. 1 and 5, inner peripheral diameters of the two-split inner rings 5A, 5B are set to be substantially the same as an outer diameter of the outer peripheral surface of the journal portion 12, and the inner peripheral surfaces of the two-split inner rings 5A, 5B are closely attached to the outer peripheral surface of the journal portion 12. Axial direction lengths of the two-split inner rings 5A, 5B are set to be slightly larger than an axial direction distance W between the crank arms 14 provided on two axial direction sides of the journal portion 12, and a predetermined fastening margin is set between such two dimensions.

The two-split inner rings 5A, 5B are first attached to the outer peripheral surface of the journal portion 12 by cold fitting or shrink fitting. That is, the two-split inner rings 5A, 5B are fitted to the outer peripheral surface of the journal portion 12 in a state where an axial direction dimension thereof is reduced by cooling, or are fitted to the outer peripheral surface of the journal portion 12 in a state where the distance W between the crank arms 14 is expanded by heating the journal portion 12.

When the two-split inner rings 5A, 5B or the journal portion 12 returns to normal temperature, the two axial direction face of the rings 5A3, 5B3 of the two-split inner rings 5A, 5B are pressed against the facing end surface portions T1 of the crank arms 14, and the two-split inner rings 5A, 5B are sandwiched and held by the crank arms 14 due to a frictional force therebetween.

Subsequently, as shown in FIGS. 5 and 6, a caulking jig 22 is pressed against the caulking margin 21 from a radial direction outer side toward a radial direction inner side so as to perform caulking over the entire circumference. The caulking margin 21 is caulked into the outer peripheral surfaces of the rib portions 5A1, 5B1 of the two-split inner rings 5A, 5B. The caulking of the caulking margin 21 caulked to the outer peripheral surface of the rib portion 5A1 of the two-split inner ring 5A is shown in FIGS. 5 and 6, and the caulking of the caulking margin 21 caulked to the outer peripheral surface of the rib portion 5B1 of the two-split inner ring 5B is also performed in the same manner. As a result, as shown in FIGS. 1 and 6, the outer peripheral surfaces of the rib portions 5A1, 5B1 of the two-split inner rings 5A, 5B are pressed and fixed radially inward by a caulked portion 23 formed by caulking the caulking margin 21 over the entire circumference.

The caulking margin 21 is pressed against the caulking jig 22 at substantially equal intervals in the peripheral direction. The caulking jig 22 may be caulked at a plurality of locations in the peripheral direction to be caulked into the outer peripheral surfaces of the rib portions 5A1, 5B1 of the two-split inner rings 5A, 5B. A plurality of the caulking margins 21 may be formed so as to protrude radially outward from the facing end surface portions T1 of the crank arms 14 at substantially equal intervals in the peripheral direction. The caulking jig 22 may be pressed against the caulking margin 21 to perform caulking, and a plurality of locations of the outer peripheral surfaces of the rib portions 5A1, 5B1 of the two-split inner rings 5A, 5B may be pressed and fixed radially inward by the caulked portion 23.

As described above in detail, in the attachment structure according to the first embodiment for attaching the rolling bearing 1 to the crankshaft 11, the caulking margins 21 extend over the entire circumference from the facing end surface portions T1 which face the two axial direction face of the rings 5A3, 5B3 of the two-split inner rings 5A, 5B of the crank arms 14. Alternatively, since the caulking margins 21 are provided so as to protrude radially outward at equal intervals along the peripheral direction, the caulking margins 21 can be easily formed.

Since the pair of rib portions 5A1 is formed on the two axial direction end edge portions of the outer peripheral surface of the two-split inner ring 5A while the pair of rib portions 5B1 is formed on the two axial direction end edge portions of the outer peripheral surface of the two-split inner ring 5B, an area of the axial direction face of the rings of the two-split inner rings 5A, 5B can be increased, a holding force of the sandwiching of a pair of the crank arms 14 can be increased, and thus a fixing force can be improved. Interference between the two-split cages 4A, 4B, which hold the rollers 3, and the crank arms 14 can be prevented, and wear of the two-split cages 4A, 4B can be prevented.

Since the caulking margin 21 is caulked to the outer peripheral surfaces of the rib portions 5A1, 5B1 of the two-split inner rings 5A, 5B, the two axial direction end edge portions of the outer peripheral surfaces of the two-split inner rings 5A, 5B are pressed radially inward and fixed by the caulked portion 23. As a result, lifting and deformation of split portions formed at two peripheral direction end portions of the two-split inner rings 5A, 5B can be reduced, and rotation of the two-split inner rings 5A, 5B with respect to the journal portion 12 can be restrained when a large load is applied to the two-split inner rings 5A, 5B. Consequently, passing vibration generated when the rollers 3 passes through the split portions can be reduced, and NV reduction can be achieved.

Since the large number of fine grooves 18 extend along the axial direction in the inner peripheral surfaces of the two-split inner rings 5A, 5B, resistance of the two-split inner rings 5A, 5B with respect to the journal portion 12 can be increased in the peripheral direction by the fine grooves 18, and the rotation of the two-split inner rings 5A, 5B with respect to the journal portion 12 can be further restrained.

### Second Embodiment

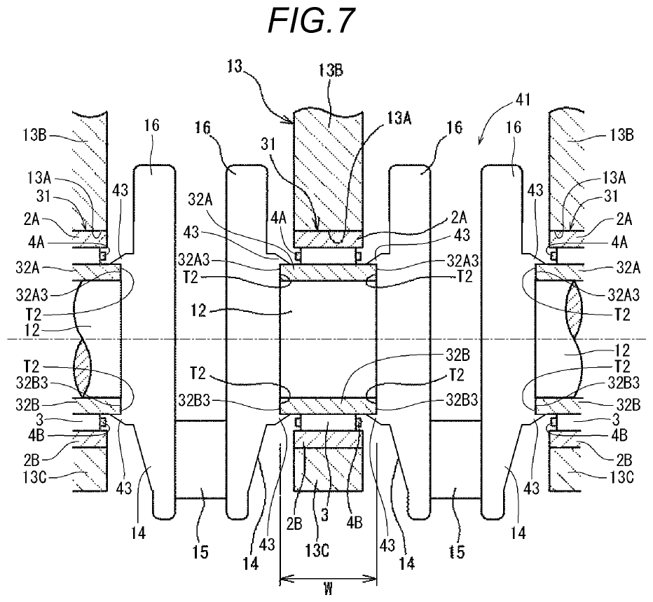

Next, a rolling bearing 31 and a crankshaft 41 according to a second embodiment will be described with reference to FIGS. 7 to 11. The same reference numerals as those of the rolling bearing 1 and the crankshaft 11 according to the first embodiment denote the same or corresponding parts as those of the rolling bearing 1 and the crankshaft 11 according to the first embodiment.

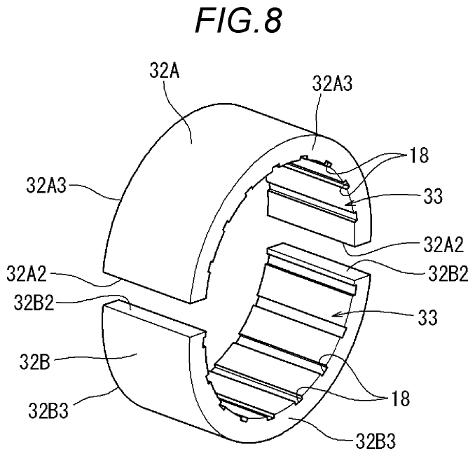

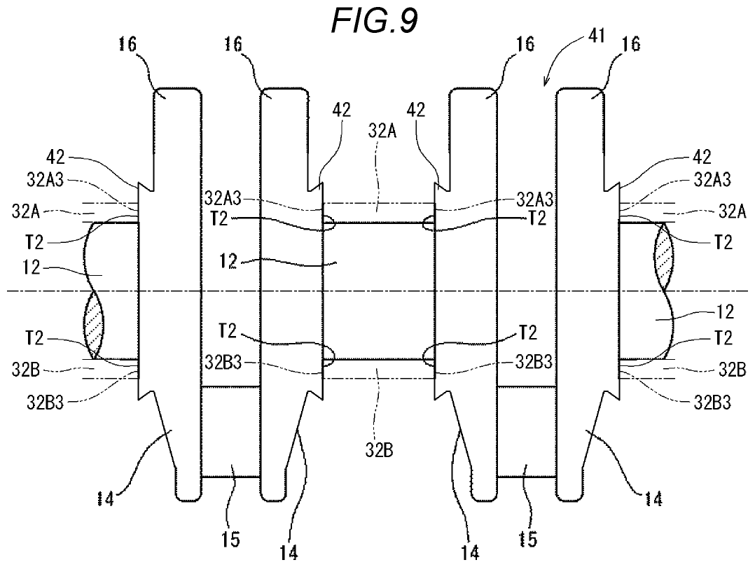

The rolling bearing 31 and the crankshaft 41 according to the second embodiment have substantially the same configuration as that of the rolling bearing 1 and the crankshaft 11 according to the first embodiment. However, as shown in FIGS. 7 and 8, the rolling bearing 31 according to the second embodiment includes a pair of two-split inner rings 32A, 32B instead of the two-split inner rings 5A, 5B, which is different from the first embodiment. As shown in FIG. 9, the crankshaft 41 includes a caulking margin 42 instead of the caulking margin 21, which is different from the first embodiment.

As shown in FIGS. 7 and 8, the two two-split inner rings 32A, 32B have substantially the same configuration as the two-split inner rings 5A, 5B, except that the rib portions 5A1, 5B1 are not formed at the two axial direction end edge portions of the outer peripheral surface. The two-split inner rings 32A, 32B respectively include divided surfaces 32A2, 32B2 whose two circumferential direction end surfaces extend straight along the axial direction. The two-split inner rings 32A, 32B abut against each other on the divided surfaces 32A2, 32B2 at two circumferential direction ends, or face each other with a slight gap therebetween formed in the circumferential direction.

The large number of fine grooves 18, which extend along the axial direction and have the depth of about 0.1 mm to 0.2 mm, are formed in inner peripheral surfaces of the two-split inner rings 32A, 32B at substantially equal intervals in the peripheral direction. Accordingly, a concave-convex structure 33 is formed on the inner peripheral surfaces of the two-split inner rings 32A, 32B by the fine grooves 18 which are substantially uniformly distributed in the peripheral direction of the inner peripheral surfaces.

As shown in FIG. 9, when the two-split inner rings 32A, 32B are fitted to the journal portion 12, the caulking margin 42 is formed, which protrudes radially outward over the entire circumference from facing end surface portions T2 of the crank arms 14 to which two axial direction face of the rings 32A3, 32B3 of the two-split inner rings 32A, 32B face. The caulking margin 42 protrudes radially outward to be flush with the facing end surface portion T2, and a radial direction cross section of an outer peripheral portion thereof is formed in the right-angled triangular shape whose diameter is continuously reduced from the one side to the other side in the axial direction. As described below, the caulking margin 42 is set to press and fix the two axial direction end edge portions of the outer peripheral surfaces of the two-split inner rings 32A, 32B when the caulking margin 42 is caulked (see FIG. 11).

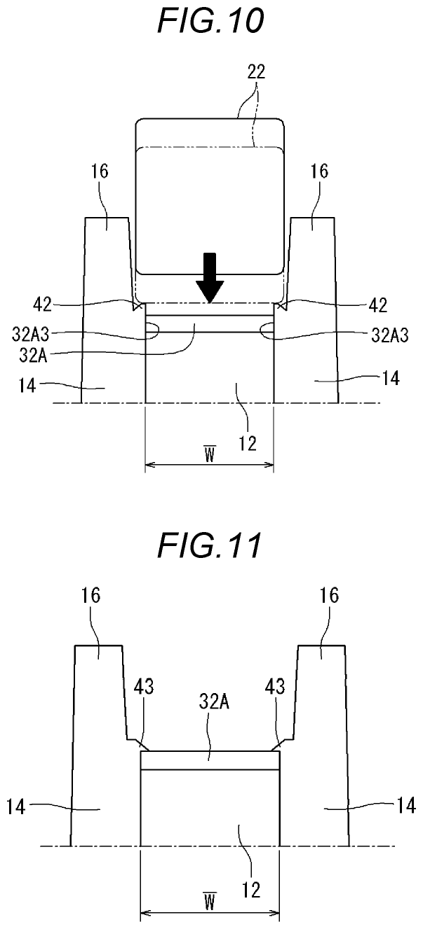

As shown in FIGS. 7 and 10, inner peripheral diameters of the two-split inner rings 32A, 32B are set to be substantially the same as the outer diameter of the outer peripheral surface of the journal portion 12, and the inner peripheral surfaces of the two-split inner rings 32A, 32B are closely attached to the outer peripheral surface of the journal portion 12. Axial direction lengths of the two-split inner rings 32A, 32B are set to be slightly larger than the axial direction distance W between the crank arms 14 provided on the two axial direction sides of the journal portion 12, and the predetermined fastening margin is set between such two dimensions.

The two-split inner rings 32A, 32B are first attached to the outer peripheral surface of the journal portion 12 by cold fitting or shrink fitting. That is, the two-split inner rings 32A, 32B are fitted to the outer peripheral surface of the journal portion 12 in a state where an axial direction dimension thereof is reduced by cooling, or are fitted to the outer peripheral surface of the journal portion 12 in the state where the distance W between the crank arms 14 is expanded by heating the journal portion 12.

When the two-split inner rings 32A, 32B or the journal portion 12 returns to the normal temperature, the two axial direction face of the rings 32A3, 32B3 of the two-split inner rings 32A, 32B are pressed against the facing end surface portions T2 of the crank arms 14, and the two-split inner rings 32A, 32B are sandwiched and held by the crank arms 14 due to a frictional force therebetween.

Subsequently, as shown in FIGS. 10 and 11, the caulking jig 22 is pressed against the caulking margin 42 from the radial direction outer side toward the radial direction inner side so as to perform caulking over the entire circumference. The caulking margin 42 is caulked into the two axial direction end edge portions of the outer peripheral surfaces of the two-split inner rings 32A, 32B. The caulking of the caulking margin 42 caulked to the outer peripheral surface of the two-split inner ring 32A is shown in FIGS. 10 and 11, and the caulking of the caulking margin 42 caulked to the outer peripheral surface of the two-split inner ring 32B is also performed in the same manner. As a result, as shown in FIGS. 7 and 11, the two axial direction end edge portions of the outer peripheral surfaces of the two-split inner rings 32A, 32B are pressed and fixed radially inward by a caulked portion 43 formed by caulking the caulking margin 42 over the entire circumference.

The caulking margin 42 is pressed against the caulking jig 22 at substantially equal intervals in the peripheral direction. The caulking jig 22 may be caulked at a plurality of locations in the peripheral direction to be caulked into the two axial direction end edge portions of the outer peripheral surfaces of the two-split inner rings 32A, 32B. A plurality of the caulking margins 42 may be formed so as to protrude radially outward from the facing end surface portions T2 of the crank arms 14 at substantially equal intervals in the peripheral direction. The caulking jig 22 may be pressed against the caulking margin 42 to perform caulking, and a plurality of locations of the two axial direction end edge portions of the outer peripheral surfaces of the two-split inner rings 32A, 32B may be pressed and fixed radially inward by the caulked portion 43.

As described above in detail, in the attachment structure according to the second embodiment for attaching the rolling bearing 31 to the crankshaft 41, the caulking margins 42 extend over the entire circumference from the facing end surface portions T2 which face the two axial direction face of the rings 32A3, 32B3 of the two-split inner rings 32A, 32B of the crank arms 14. Alternatively, since the caulking margins 42 are provided so as to protrude radially outward at equal intervals along the peripheral direction, the caulking margins 42 can be easily formed.

In a state where the pair of two-split inner rings 32A, 32B are sandwiched and held by the pair of crank arms 14 in the axial direction, the caulking margin 42 is caulked to the two axial direction end edge portions of the outer peripheral surfaces of the pair of two-split inner rings 32A, 32B. As a result, since the two axial direction end edge portions of the outer peripheral surfaces of the two-split inner rings 32A, 32B are pressed radially inward and fixed by the caulking, lifting and deformation of split portions formed at two peripheral direction end portions of the two-split inner rings 32A, 32B can be reduced, and rotation of the two-split inner rings 32A, 32B with respect to the journal portion 12 can be restrained when a large load is applied to the two-split inner rings 32A, 32B. Consequently, the passing vibration generated when the rollers 3 passes through the split portions can be reduced, and the NV reduction can be achieved.

Since the large number of fine grooves 18 extend along the axial direction in the inner peripheral surfaces of the two-split inner rings 32A, 32B, resistance of the two-split inner rings 32A, 32B with respect to the journal portion 12 can be increased in the peripheral direction by the fine grooves 18, and the rotation of the two-split inner rings 32A, 32B with respect to the journal portion 12 can be further restrained.

### Third Embodiment

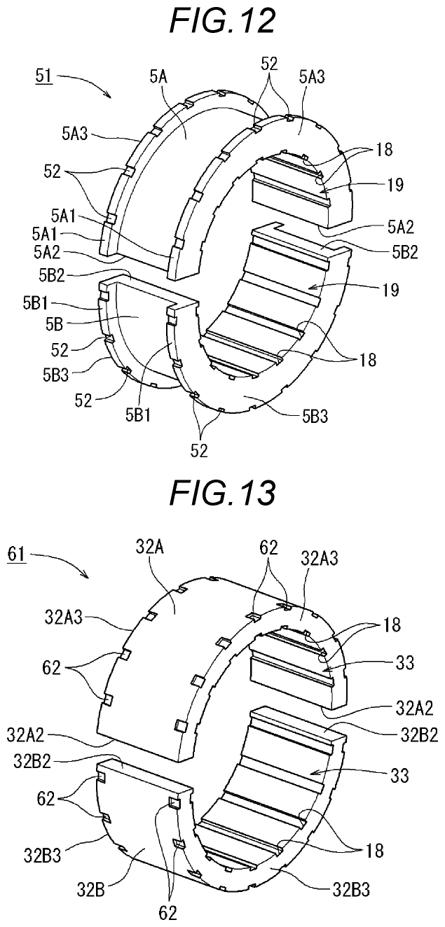

Next, a rolling bearing 51 according to a third embodiment will be described with reference to FIG. 12. The same reference numerals as those of the rolling bearing 1 and the crankshaft 11 according to the first embodiment denote the same or corresponding parts as those of the rolling bearing 1 and the crankshaft 11 according to the first embodiment.

The rolling bearing 51 according to the third embodiment have substantially the same configuration as that of the rolling bearing 1 according to the first embodiment. However, as shown in FIG. 12, a large number of recessed portions 52 having a depth of about 0.1 mm to 0.2 mm are formed at substantially equal intervals in the peripheral direction in the outer peripheral surfaces of the rib portions 5A1, 5B1 protruding radially outward with a predetermined width (for example, a width of about 3 mm) from the two axial direction end edge portions of the outer peripheral surfaces of the pair of two-split inner rings 5A, 5B. The recessed portions 52 are formed along the axial direction over entire widths of each of the rib portions 5A1, 5B1.

The attachment structure configured as described above according to the third embodiment for attaching the rolling bearing 51 to the crankshaft 11 has the following advantageous effects in addition to advantageous effects achieved by the attachment structure according to the first embodiment for attaching the rolling bearing 1 to the crankshaft 11. Specifically, when the caulking margins 21 are caulked over the entire circumference of the outer peripheral surfaces of the rib portions 5A1, 5B1 of the two-split inner rings 5A, 5B, the caulking margins 21 fit into the recessed portions 52. As a result, the rotation of the two-split inner rings 5A, 5B with respect to the journal portion 12 can be further restrained.

### Fourth Embodiment

Next, a rolling bearing 61 according to a fourth embodiment will be described with reference to FIG. 13. The same reference numerals as those of the rolling bearing 31 and the crankshaft 41 according to the second embodiment denote the same or corresponding parts as those of the rolling bearing 31 and the crankshaft 41 according to the second embodiment.

The rolling bearing 61 according to the fourth embodiment have substantially the same configuration as that of the rolling bearing 31 according to the second embodiment. However, as shown in FIG. 13, a large number of recessed portions 62 having a depth of about 0.1 mm to 0.2 mm are formed with a predetermined width (for example, a width of about 3 mm) at substantially equal intervals in the peripheral direction in the two axial direction end edge portions of the outer peripheral surfaces of the pair of two-split inner rings 32A, 32B. Each recessed portion 62 is formed along the axial direction, and is formed in a groove shape that is notched to the two axial direction face of the rings so as to have a constant depth or a gradually increasing depth toward an axial direction outer side.

The attachment structure configured as described above according to the fourth embodiment for attaching the rolling bearing 61 to the crankshaft 41 has the following advantageous effects in addition to advantageous effects achieved by the attachment structure according to the second embodiment for attaching the rolling bearing 31 to the crankshaft 41. Specifically, when the caulking margins 42 are caulked over the entire circumference of the two axial direction end edge portions of the outer peripheral surfaces of the two-split inner rings 32A, 32B, the caulking margins 42 fit into the recessed portions 62. As a result, the rotation of the two-split inner rings 32A, 32B with respect to the journal portion 12 can be further restrained.

### Fifth Embodiment

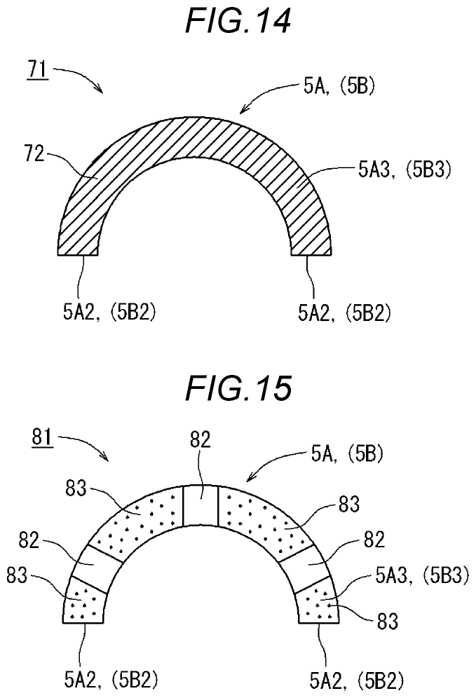

Next, a rolling bearing 71 according to a fifth embodiment will be described with reference to FIG. 14. The same reference numerals as those of the rolling bearing 1 and the crankshaft 11 according to the first embodiment denote the same or corresponding parts as those of the rolling bearing 1 and the crankshaft 11 according to the first embodiment.

The rolling bearing 71 according to the fifth embodiment have substantially the same configuration as that of the rolling bearing 1 according to the first embodiment. However, as shown in FIG. 14, a concave-convex structure 72 configured by oblique knurls, which are formed by knurling over the entire circumference and obliquely inclined with respect to the divided surfaces 5A2, 5B2, is substantially uniformly distributed in the peripheral direction on the two axial direction face of the rings 5A3, 5B3 of the pair of two-split inner ring 5A, 5B.

The concave-convex structure 72 configured by the oblique knurls is formed before heat treatment for curing necessary portions of the two-split inner rings 5A, 5B is performed. Although the described concave-convex structure 72 is configured by the oblique knurls, the concave-convex structure 72 may also be configured by vertical knurls perpendicular to the divided surfaces 5A2, 5B2, or lattice knurls intersecting in a mesh pattern.

The attachment structure configured as described above according to the fifth embodiment for attaching the rolling bearing 71 to the crankshaft 11 has the following advantageous effects in addition to advantageous effects achieved by the attachment structure according to the first embodiment for attaching the rolling bearing 1 to the crankshaft 11. Specifically, by attaching the two-split inner rings 5A, 5B to the outer peripheral surface of the journal portion 12 by cold fitting or shrink fitting, the facing end surface portions T1 of the crank arms 14, which face the two axial direction face of the rings 5A3, 5B3 of the two-split inner rings 5A, 5B, are fitted into and pressure contact with the concave-convex structure 72 configured by the oblique knurls. As a result, the rotation of the two-split inner rings 5A, 5B with respect to the journal portion 12 can be further restrained.

A concave-convex structure, which is configured by knurls formed by knurling over the entire circumference, such as oblique knurls obliquely inclined with respect to the divided surfaces 32A2, 32B2, vertical knurls perpendicular to the divided surfaces 32A2, 32B2, or lattice knurls intersecting in a mesh pattern, may also be formed on the two axial direction face of the rings 32A3, 32B3 of the pair of two-split inner rings 32A, 32B according to the second embodiment with equal intervals in the peripheral direction.

As a result, by attaching the two-split inner rings 32A, 32B to the outer peripheral surface of the journal portion 12 by cold fitting or shrink fitting, the facing end surface portions T2 of the crank arms 14, which face the two axial direction face of the rings 32A3, 32B3 of the two-split inner rings 32A, 32B, are fitted into and pressure contact with the concave-convex structure configured by the oblique knurls, the vertical knurls or the lattice knurls intersecting in the mesh pattern. As a result, the rotation of the two-split inner rings 32A, 32B with respect to the journal portion 12 can be further restrained.

### Sixth Embodiment

Next, a rolling bearing 81 according to a sixth embodiment will be described with reference to FIG. 15. The same reference numerals as those of the rolling bearing 1 and the crankshaft 11 according to the first embodiment denote the same or corresponding parts as those of the rolling bearing 1 and the crankshaft 11 according to the first embodiment.

The rolling bearing 81 according to the sixth embodiment have substantially the same configuration as that of the rolling bearing 1 according to the first embodiment. However, as shown in FIG. 15, a plurality of (for example, three) cutout grooves 82, which extend over the entire width along the radial direction and have a depth of 0.1 mm to 0.2 mm, are formed in the two axial direction face of the rings 5A3, 5B3 of the pair of two-split inner rings 5A, 5B at equal intervals in the peripheral direction. At least one cutout groove 82 may be formed in each of the two axial direction face of the rings 5A3, 5B3. A concave-convex portion 83 having a satin pattern or the like is formed by surface roughening such as sandblasting or etching in portions of the two axial direction face of the rings 5A3, 5B3 excluding the cutout grooves 82.

The attachment structure configured as described above according to the sixth embodiment for attaching the rolling bearing 81 to the crankshaft 11 has the following advantageous effects in addition to advantageous effects achieved by the attachment structure according to the first embodiment for attaching the rolling bearing 1 to the crankshaft 11. Specifically, by attaching the two-split inner rings 5A, 5B to the outer peripheral surface of the journal portion 12 by cold fitting or shrink fitting, the facing end surface portions T1 of the crank arms 14, which face the two axial direction face of the rings 5A3, 5B3 of the two-split inner rings 5A, 5B, are fitted into and pressure contact with the cutout grooves 82 and the concave-convex portion 83 having the satin pattern or the like. As a result, the rotation of the two-split inner rings 5A, 5B with respect to the journal portion 12 can be further restrained.

The plurality of (for example, three) cutout grooves 82, which extend over the entire width along the radial direction and have a depth of 0.1 mm to 0.2 mm, may also be formed in the two axial direction face of the rings 32A3, 32B3 of the pair of two-split inner rings 32A, 32B according to the second embodiment at equal intervals in the peripheral direction. At least one cutout groove 82 may be formed in each of the two axial direction face of the rings 32A3, 32B3. The concave-convex portion 83 having the satin pattern or the like may also be formed by surface roughening such as sandblasting or etching in portions of the two axial direction face of the rings 32A3, 32B3 excluding the cutout grooves 82.

As a result, by attaching the two-split inner rings 32A, 32B to the outer peripheral surface of the journal portion 12 by cold fitting or shrink fitting, the facing end surface portions T2 of the crank arms 14, which face the two axial direction face of the rings 32A3, 32B3 of the two-split inner rings 32A, 32B, are fitted into and pressure contact with the cutout grooves 82 and the concave-convex portion 83 having the satin pattern or the like. As a result, the rotation of the two-split inner rings 32A, 32B with respect to the journal portion 12 can be further restrained.

The present invention is not limited to the first to sixth embodiments, and various improvements, modifications, additions, and deletions may be made without departing from the scope of the present invention. In the following description, the same reference numerals as those of configurations and the like of the rolling bearing 1 and the crankshaft 11 according to the first embodiment of FIGS. 1 to 6 denote the same or corresponding parts as those of the configurations and the like of the rolling bearing 1 and the crankshaft 11 according to the first embodiment. The same reference numerals as those of configurations and the like of the rolling bearing 31 and the crankshaft 41 according to the second embodiment of FIGS. 7 to 11 denote the same or corresponding parts as those of the configurations and the like of the rolling bearing 31 and the crankshaft 41 according to the second embodiment.

(A) For example, instead of the fine grooves 18, the concave-convex structure 19 or the concave-convex structure 33, which is formed by the oblique knurls formed by knurling and obliquely inclined with respect to the circumferential direction over the entire circumference, the vertical knurls along the peripheral direction, or the lattice knurls intersecting in the mesh pattern, may be formed on the inner peripheral surfaces of the pair of two-split inner rings 5A, 5B or the inner peripheral surfaces of the two-split inner rings 32A, 32B so as to be substantially uniformly distributed in the peripheral direction and the axial direction. The concave-convex structure 19 or the concave-convex structure 33, which is formed by the oblique knurls, the vertical knurls or the lattice knurls intersecting in the mesh pattern is formed before heat treatment for curing necessary portions of the two-split inner rings 5A, 5B or the two-split inner rings 32A, 32B is performed.

As a result, by attaching the two-split inner rings 5A, 5B to the outer peripheral surfaces of the journal portion 12 by cold fitting or shrink fitting, the resistance of the two-split inner rings 5A, 5B with respect to the journal portion 12 can be increased in the peripheral direction, and the rotation of the two-split inner rings 5A, 5B with respect to the journal portion 12 can be further restrained. By attaching the two-split inner rings 32A, 32B to the outer peripheral surfaces of the journal portion 12 by cold fitting or shrink fitting, the resistance of the two-split inner rings 32A, 32B with respect to the journal portion 12 can be increased in the peripheral direction, and the rotation of the two-split inner rings 32A, 32B with respect to the journal portion 12 can be further restrained.

This application is based on JP-A-2017-240786 filed on Dec. 15, 2017, the contents of which are incorporated herein by reference.

### REFERENCE SIGNS LIST

1, 31, 51, 61, 71, 81 Rolling bearing
2A, 2B Two-split outer ring
3 Roller
4A, 4B Cage
5A, 5B, 32A, 32B Two-split inner ring
5A1, 5B1 Rib portion
5A3, 5B3, 32A3, 32B3 Axial direction face of the ring
11, 41 Crankshaft
12 Journal portion
14 Crank arm
18 Fine groove
19, 33, 72 Concave-convex structure
21, 42 Caulking margin
23, 43 Caulked portion
52, 62 Recessed portion

1. A rolling bearing attachment structure for attaching a rolling bearing to a journal portion of a crankshaft, comprising:
the rolling bearing; and
the crankshaft,
wherein the rolling bearing includes:
a pair of two-split inner rings which is attached to an outer peripheral surface of the journal portion and is split into two portions in a circumferential direction;
a pair of two-split outer rings which is provided on outer sides of the pair of two-split inner rings in a radial direction and is split into two portions in the circumferential direction;
a plurality of rolling elements rotatably provided between the pair of two-split outer rings and the pair of two-split inner rings; and
a cage which holds the plurality of rolling elements at substantially equal intervals in the circumferential direction,
wherein the crankshaft includes a pair of crank arms provided on two axial direction sides of the journal portion,
wherein the pair of crank arms includes a caulking margin, at least a part of the caulking margin in a peripheral direction protruding radially outward from a facing end surface facing an axial direction face of the pair of two-split inner rings,
wherein the pair of two-split inner rings is sandwiched in an axial direction by the pair of crank arms, and
wherein an outer peripheral surface of the pair of two-split inner rings is fixed by a caulked portion formed by caulking the caulking margin.

2. The rolling bearing attachment structure according to claim 1,
wherein the pair of two-split inner rings includes a pair of rib portions which protrudes radially outward from two axial direction end portions, and
wherein the caulking margin is caulked to an outer peripheral surface of the pair of rib portions.

3. The rolling bearing attachment structure according to claim 1,
wherein the pair of two-split inner rings includes a plurality of recessed portions formed at equal intervals in the peripheral direction in the outer peripheral surface where the caulking margin is caulked.

4. The rolling bearing attachment structure according to claim 1,
wherein the pair of two-split inner rings includes a concave-convex structure constituted by a plurality of recessed portions or protruding portions formed at equal intervals in the peripheral direction in two axial direction face of the rings.

5. The rolling bearing attachment structure according to claim 1,
wherein the pair of two-split inner rings includes a concave-convex structure constituted by a plurality of recessed portions or protruding portions formed at equal intervals in the peripheral direction in an inner peripheral surface.
